(19) United States
(12) Patent Application Publication
(10) Pub. No.: US 2020/0264381 A1
(43) Pub. Date: Aug. 20, 2020

(54) MECHANICAL SPLICE ASSEMBLY FOR SPLICING OPPOSING OPTICAL FIBERS WITHIN A FIBER OPTIC CONNECTOR AND METHOD OF PERFORMING THE SAME

(71) Applicant: Senko Advanced Components Inc, Marlborough, MA (US)

(72) Inventors: Guanpeng HU, Shanghai (CN); Man Kit WONG, Kowloon (HK)

(73) Assignee: Senko Advanced Components, Inc, Marlborough, MA (US)

(21) Appl. No.: 16/793,875

(22) Filed: Feb. 18, 2020

Related U.S. Application Data
(60) Provisional application No. 62/807,211, filed on Feb. 18, 2019.

(51) Int. Cl. G02B 6/38; G02B 6/25

(52) U.S. Cl. CPC G02B 6/3803; G02B 6/25; G02B 6/3802

(57) ABSTRACT

A field installable fiber optical connector formed using a mechanical splice assembly secured within an opening of a plug frame. A fiber optical cable is secured to a distal end of a rear body that is secured to a distal end of the plug frame.

### CROSS REFERENCE TO RELATED APPLICATIONS

This application claims priority to U.S. Provisional Patent application No. 62/807,211 filed Feb. 18, 2019 titled “A Mechanical Splice Apparatus for Optical Fiber and Fiber Mechanical Splice Connector, LC Type” which is fully incorporated by reference.

### FIELD OF THE INVENTION

The present disclosure relates generally to fiber optic connectors and systems, and specifically to splicing opposing optical fibers within a fiber optic connector in the field or called a field installable splicing fiber optic connector.

### BACKGROUND

The prevalence of the Internet has led to unprecedented growth in communication networks. Consumer demand for service and increased competition has caused network providers to continuously find ways to improve quality of service while reducing cost.

Solutions deployed in the field require splicing or interconnecting opposing optical fibers to interconnect networks, or devices using optical fibers to communicate data.

Optical fiber is typically glass. The glass has an outer jacket, inner strength or reinforcing fibers and a covering. These components are stripped and pulled back. The glass fiber is cleaved, inserted into a ferrule assembly and polished. The glass fiber is polished at a proximal end of the connector. Ferrule assembly is inserted into a connector housing and secured therein. The distal end of the fiber cable is secured with a crimp ring and a crimp boot. Alternatively, an optical fiber may be 100% polymer or plastic.

There is a need to improve aligning of the mechanical splice assembly during splicing in the X-axis, Y-axis and Z-axis to ensure to ensure opposing endfaces of optical fibers are perpendicular such that the maximum light transmission occurs between the opposing optical fibers.

Prior art devices depend on a V-groove of averaged size to accept various optical fiber sizes. A smaller optical fiber than the V-groove dimension would allow the opposing fibers to become offset increasing signal loss between the endfaces of the opposing optical fibers.

### SUMMARY OF THE INVENTION

The present invention reduces time to form a mechanical splice in the field. A first fiber is a short tail of optical fiber extending from a ferrule and a second fiber is provided by a fiber optic cable. Time is reduced when a fiber press block self-orients with a base unit to secure the opposing fibers without causing movement of either opposing fiber, within a V groove formed in the base, such that the first optical fiber and/or the second optic fiber become offset along a longitudinal axis of a fiber optic connector. When the opposing fibers become offset light is lost and this results in signal loss. FIG. 15 depicts the proper alignment of opposing optical fibers to ensure minimum insertion loss.

In the present invention, the mechanical splice assembly consists of a splice cap, a fiber press block and a base, which holds opposing optical fibers in a v-groove. The assembly is sized to fit with a fiber optic connector housing. The fiber press block has a plural of tabs and cutouts that mate with the splice cap and base that ensures the optical fibers are retained without movement along the longitudinal axis or x-axis of the optical fiber including the Y and Z directions, as depicted in FIG. 7A. The cap deforms the V-groove about the optical fibers securing against X, Y or Z axis movement the opposing optical fibers.

In a second embodiment, a cable cover is depicted at FIG. 9. The cable cover mates with a housing to secure the fiber optic cable from moving during use. The cable cover helps to prevent longitudinal movement of the second optical fiber opposing the first optical fiber, in the v-groove at the mechanical splice joint. Increasing the gap space (at FIG. 15) increases signal loss when the light signal is transmitted across the air interface and becomes bent or distorted.

The present invention discloses a method of forming a splice joint. The first optic fiber is provided at a distal end of a ferrule. The ferrule may contain one optical fiber, or a mechanical transfer ferrule that contains a plural of optical fibers. The second optical fiber is provided as part of a fiber optic cable. The outer cable jacket and strength members are removed, and the optical fiber is cleaved or terminated to form a ninety (90) degree endface with the longitudinal X axis of the optical fiber. The opposing optical fibers are positioned or abutted in the V-groove located in the base. The fiber press block is inserted into an opening in the base, with the splice cap secured about the fiber press block closing the opening formed in the base. A cable cover is secures the jacketed optical cable at a distal end of the fiber optic connector to help prevent movement of the splice optical fiber provided by the cable.

### BRIEF DESCRIPTION OF THE DRAWINGS

FIG. 1A is a perspective view of the present invention mechanical splice assembly;

FIG. 1B depicts a splice cap partially removed from a base of the mechanical splice assembly of FIG. 1;

FIG. 2 depicts a V-groove in a bottom portion of the base of FIG. 1;

FIG. 3A.1 depicts a perspective view of base of FIG. 1;

FIG. 3A.2 depicts a perspective view of the fiber press block;

FIG. 3B defines “X” position, “Y” position and “Z” position of the assembly;

FIG. 3C depicts an exploded view of FIG. 1 with arrow “A” showing assembly direction;

FIG. 3D depicts a perspective view of the splice cap of FIG. 1;

FIG. 4A depicts a plural of positioning features of the fiber press block inserted in the base;

FIG. 4B depicts a second side or bottom side of the fiber press block;

FIG. 4C.1 depicts inserting the splice cap over the fiber press block within the base along section A-A at a first end of the splice cap of FIG. 3C;

FIG. 4C.2 depicts inserting the splice cap over the fiber press block within the base along section B-B at FIG. 3A.2;

FIG. 5A depicts splice cap positioned within base opening along section C-C of FIG. 4A illustrating opposing latch legs;

FIG. 5B depicts splice cap operation of FIG. 4C.2 within fiber press block;

FIG. 6A depicts splice cap being position within fiber press block as described in FIG. 5B or V-groove is in an open state;

FIG. 6B depicts splice cap fully inserted within base, activating fiber press block to secure opposing optical fibers in V-groove of base or V-groove is in a closed state;

FIG. 7A depicts splice cap fully secured within base along section C-C at FIG. 4A;

FIG. 7B depicts Z axis positioning of the fiber optic press block;

FIG. 8A depicts fiber guidance areas along the longitudinal “X” axis of the mechanical splice assembly;

FIG. 8B depicts installing a first optical fiber using the fiber guidance areas of FIG. 8A;

FIG. 8C depicts installing a second optical fiber, opposite the first optical fiber, using the fiber guidance areas of FIG. 8A;

FIG. 8D depicts positioning the splice cap in the opening of the base;

FIG. 8E depicts fully inserting the splice cap in the opening of the base;

FIG. 9 is an exploded view of fiber optic connector being formed using the mechanical splice assembly;

FIG. 10A is a cross-section of the fiber optic connector assembled with the mechanical splice assembly and a cable cover securing the fiber optic cable;

FIG. 10B depicts assembled fiber optic connector without the cable cover installed;

FIG. 11A depicts optical fiber cable preparation;

FIG. 11B depicts installing prepared cable as part of fiber optic connector with the mechanical splice assembly;

FIG. 11C depicts the cross-section of FIG. 11B;

FIG. 11D depicts the cable cover forming the final fiber optic mechanically spliced connector;

FIG. 11E depicts latching of endcap to fiber optic rear body;

FIG. 12 depicts exploded view of latch points to secure cable cover to rear body;

FIG. 13A depicts the rear body prior to securing the cable cover with an optical cable secured between elastic ribs;

FIG. 13B is a perspective view of the cable cover;

FIG. 14 depicts a cross-section of cable cover securing the fiber optic cable, and

FIG. 15 is a perceptive view of opposing optical fibers just prior to abutting to form a mechanical splice joint.

### DETAILED DESCRIPTION

The following terms shall have, for the purposes of this application, the respective meanings set forth below.

A connector is a device the completes a communication path from an optical fiber strand that transmits a light signal to another connector or to transceiver electronics. The electronics convert the light signal into a digital signal. A connector is inserted and secured at either end of adapter, for example, a ferrule connector (PC), a fiber distributed data interface (FDDI) connector, an LC connector, a mechanical transfer (MT) connector, a standard connector (SC) connector, an SC duplex connector, or a straight tip (ST) connector. The connector may be defined by a connector housing body, an external latch or recess to secure said connector into adapter opening and one or more ferrules having optic fibers therein. In some embodiments, the housing body may incorporate any or all of the components described herein.

A receptacle is an adapter with internal structure to secure a proximal end or ferrule end of a connector within a port or opening. An adapter allows a first and second connector to interconnect or oppose each other to transmit a light signal from one part of a cable assembly to another, as an example. A receptacle may be a transceiver with an opening to receive a connector.

A “fiber optic cable” or an “optical cable” refers to a cable containing one or more optical fibers for conducting optical signals in beams of light. The optical fibers can be constructed from any suitable transparent material, including glass, fiberglass, polymer optical fiber, or plastic. The cable can include a jacket or sheathing material surrounding the optical fibers. Between the outer sheath and the optical fiber are strands of strength members or tensile members. In addition, the cable can be connected to a connector on one end or on both ends of the cable.

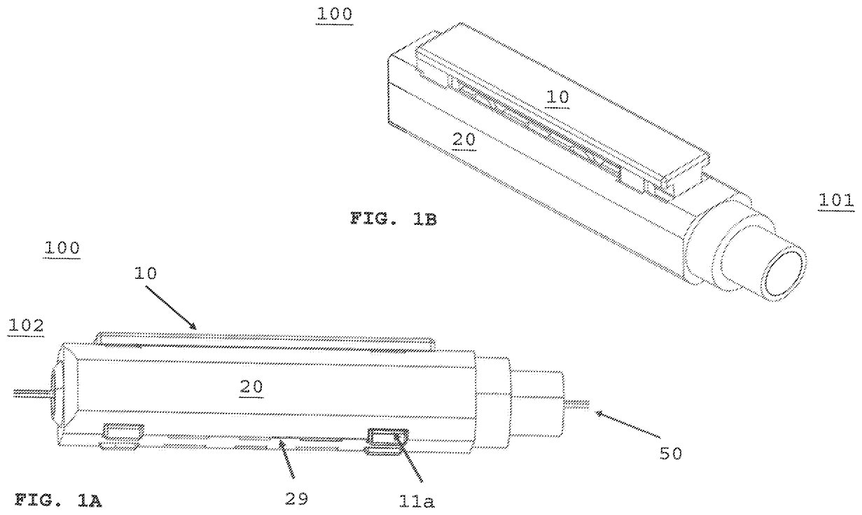

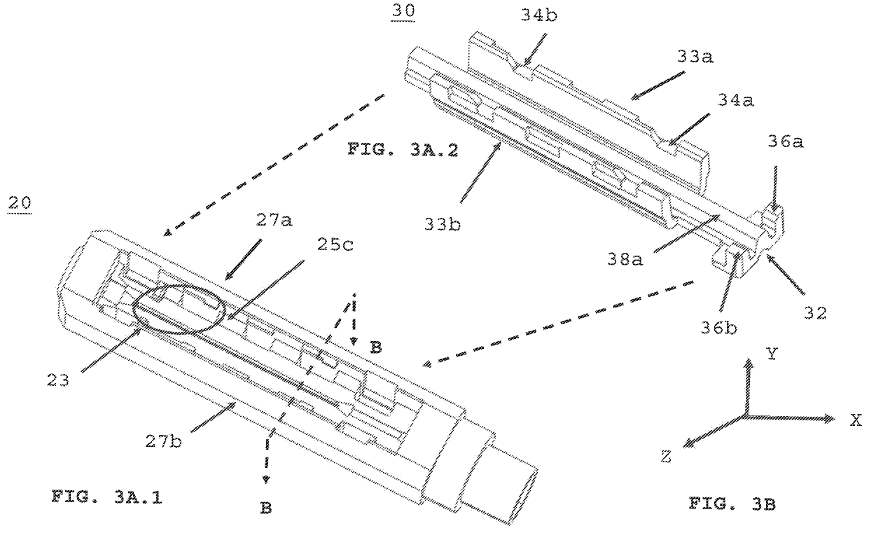

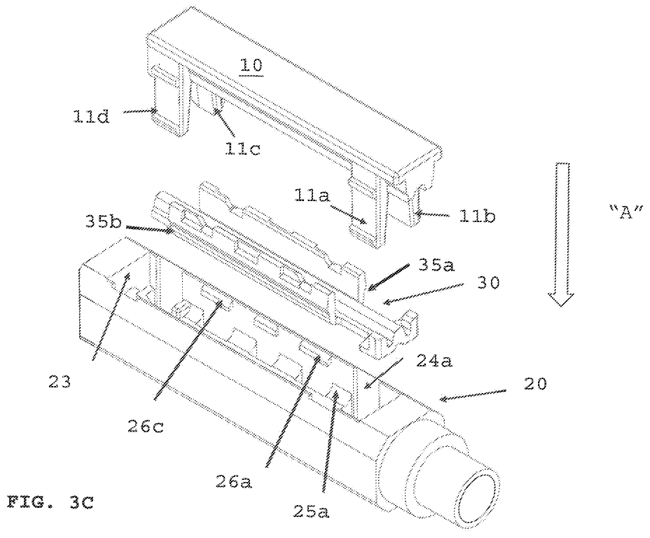

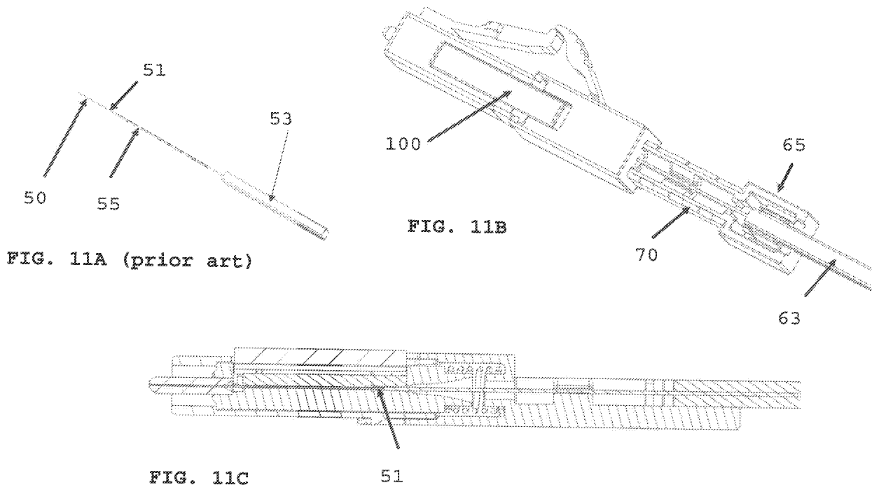

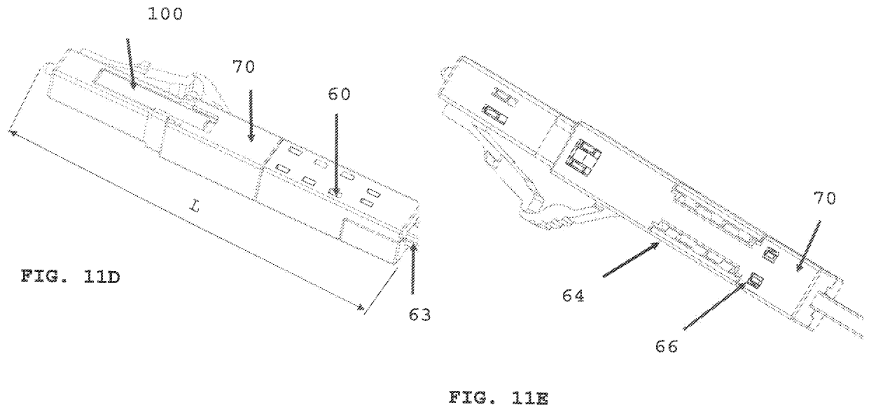

FIG. 1A depicts mechanical splice assembly (100) splicing optical pigtail (51) (FIG. 11A) and an optical fiber (50′) formed as part of optical cable (62) (FIG. 15). Proximal end (102) receives the pigtail and distal end (100) receives the optical cable. Splice cap (10) secures fiber press block (30) (FIG. 3A) within base (20). Splice cap (10) has plural of latch legs (11A-11D) on opposite side of splice cap top surface (12) (FIG. 3C). The latch legs are positioned perpendicular through the base and latch at bottom portion (29) of the base thereby securing the fiber press block within the base. Once secured, the opposing optic fibers are spliced together as depicted in FIG. 15. FIG. 1B depicts splice cap (10) before fully inserted into base (20). The optical fiber may be polymer optical fiber (50) or a glass optical fiber with a protective coating and outer sheath (refer to 11A).

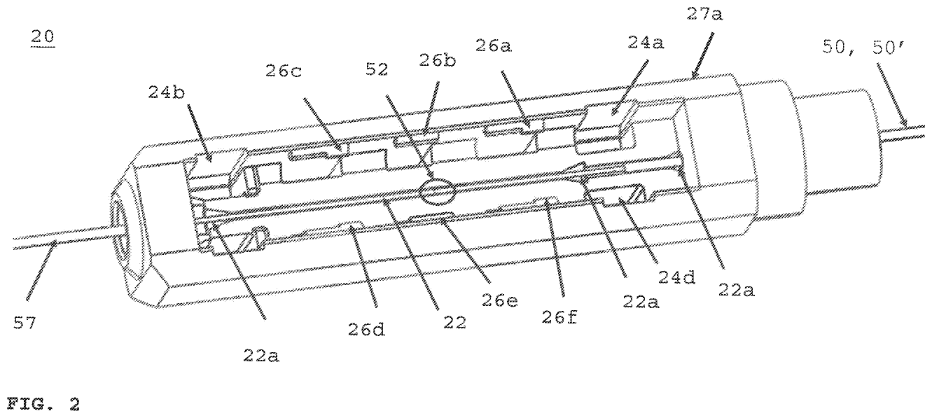

FIG. 2 depicts base (20) with opening (23). Base sidewalls (27a, 27b) (FIG. 3A.1) have a plural of latches and recesses configured to secure the fiber press block and the splice cap. Base sidewalls (27a, 27b) have a plural of recess (24a-24d) that receive latch legs (11a-11d) respectively. The sidewalls further comprise a plural of inner catches (26a-26f). Inner catches (26a, 26c, 26d, 26f) captures and secures fiber press block (30), and raised edge (16a, 16b) formed as part of splice cap (10) sidewall (13a, 13b) is further secured by inner catches (26b, 26e). Base (20) further comprises v-groove (22) with pigtail (51) guided through guide channel (22a) at proximal end (102), and optical fiber (50, or 50′) feed through guide channels (22a) at distal end (101) being spliced at splice joint (52).

Referring to FIG. 3A.1, FIG. 3A.2 and FIG. 3B, FIG. 3A.1 depicts a view of base (20) and FIG. 3A.2 depicts a view of fiber press block (30). Refer to FIG. 3A.1, opening (23) accepts fiber press block (30). Fiber press block (30) comprises longitudinal upper groove (32) with opposing sidewalls (33a, 33b). Recesses (34a-34d) are secured below inner catches (24a, 24c, 24d, 24f). Refer to FIG. 3A.2, raised channel (38a) sets “X” position of splice cap (10) when secured with the base. Protrusions (36a, 36b) sets “Y” position of splice cap (10) or depth of the splice cap when secured within the base. FIG. 3B depicts positioning of splice cap (20) within the base. “X” position defines the movement of the splice cap along a longitudinal direction from the proximal end to the distal end of the mechanical splice assembly. “Y” position defines the depth of the splice cap within the base. “Z” direction defines the distance between base sidewalls (27a, 27b) and fiber press block (30).

FIG. 3C depicts an exploded view of mechanical splice assembly (100). Splice cap (10) comprises top surface (12) (FIG. 3D), a plural of latch legs (11a-11d) attached to sidewalls (13a, 13b) (FIG. 3D). Each sidewall has a raised edge (16a, 16b) from the proximal end to the distal end of the splice cap. Raised edge is secured by inner catches (26b, 26e). Longitudinal channel (14) accepts X-position (38a). Fiber press block (30) comprises sidewalls (35a, 35b). Base (20) opening (23) receives fiber press block (30). Inner catches (26a, 26c) secures the fiber press block at sidewall (35a, 35b) respectively. Receiver guides (25a-25f) orients fiber press block (20) within the base opening.

FIG. 3D depicts splice cap (10). Splice cap (10) further comprises top surface (12), plural of legs (11a, 11c, lie, 11g), and two latches per a latch leg that extend perpendicular from each leg. Bottom latches (11a.1, 11c.1, 11e.1, 11g.1) pass through recesses (24a-24d) respectively, and are secured on bottom surface (29) (FIG. 1) of base (20). This ensures the splice cap fixes the fiber press block within the opening of the base, and fixes the opposing optical fibers from moving to ensure opposing fibers optical signal lose is minimized, or low insertion loss. Upper latches (11b.1, 11d.1, 11f.1, 11h.1) provides support along the “Z” position. Each latch leg has a chamfer formed at the base of the latch leg. For example, chamfer (11a.1.a, 11g.1.a) slopes at about 45 degrees from the normal away from the tip of the latch generally in the negative “Z”−“Y” direction or quadrant defined in FIG. 3B. This allows each latch leg to bend slightly inward under the force of base (20) sidewalls (27a, 27b), and when positioned through the opening at bottom portion (20) formed by recesses (24a-24d), latch legs (11a-11g) relax outward which secures each bottom catch (11a.1-11d.1) on the outer wall of the bottom portion, thereby, securing the fiber press block (30) within base (20), and closing v-groove (20) about splice point (52) forming the mechanical splice.

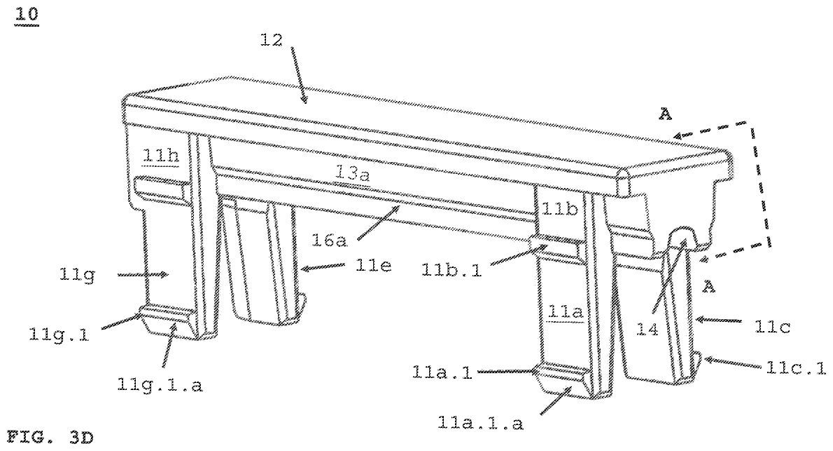

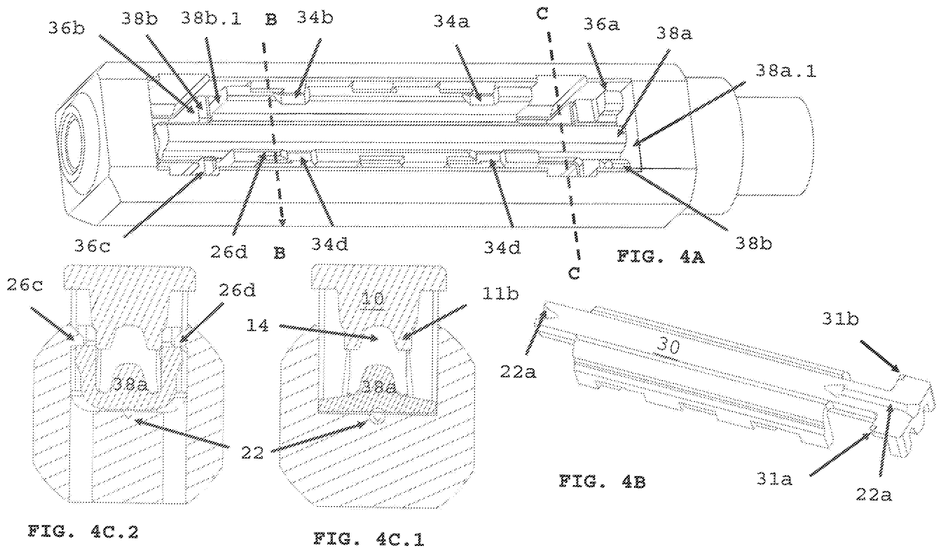

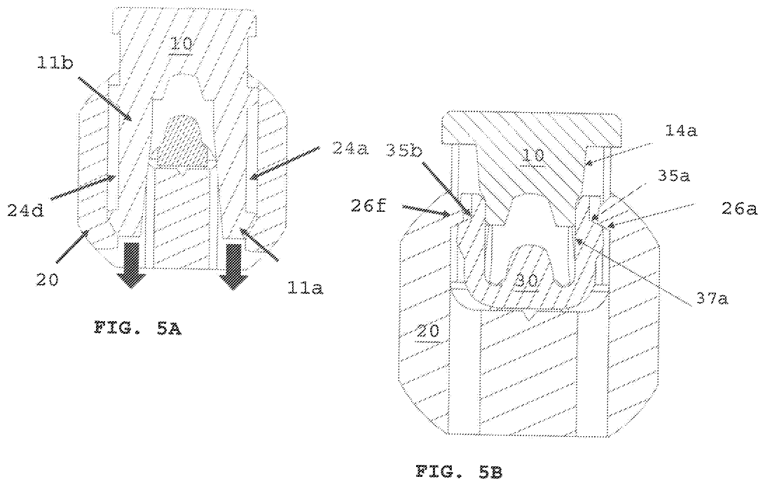

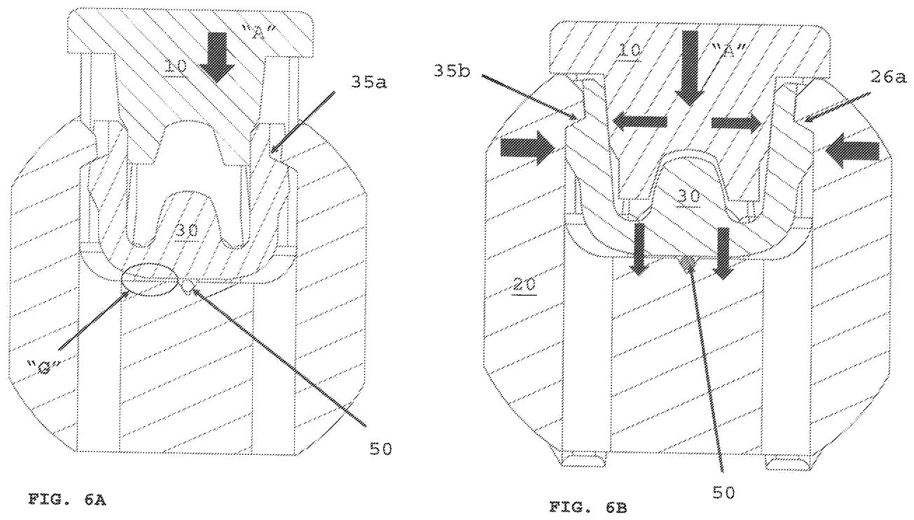

Referring to FIG. 4A, FIG. 4B, FIG. 4C.1 and FIG. 4C.2, FIG. 4A depicts a top view of fiber press block (30) inserted and secured within opening (23) of base (20). FIG. 4C.2 depicts cross-section at line B-B. FIG. 5A depicts cross-section at line C-C. Protrusions (38a-38b) and surface (38a.1, 38b.1) defines the “X” position or longitudinal movement of splice cap (10) when inserted fully into the base opening (23) to secure optical fiber splice joint (52) in a closed position as described in FIG. 6B. Surfaces (36a-36c) defines “Y” position or controls the depth of splice cap (10) when fully inserted into opening (23). Cut-outs (34a-34d) controls “Z” position or movement perpendicular to the longitudinal axis of the mechanical splice assembly. FIG. 4B depicts fiber press block (20) at a second side comprising fiber guide channels (22a), and a pair of opposing removal cut-outs (31a, 31b) to lift the fiber press block after being inserted into the base. FIG. 4C.1 depicts splice cap (10) partially inserted into opening (23) along section line A-A of FIG. 3D. Channel (14) mates with longitudinal protrusion (38a) to center splice cap (10) in the “X” position over the optical fiber within V-groove (22). FIG. 4C.2 depicts splice cap (10) being inserted into opening (23) along section B-B of FIG. 3A. Fiber press block is secured beneath inner catches (26a, 26c, 26d, 26f) thereby positioning the fiber press block in the “Z” direction within the base.

FIG. 5A depicts splice cap (10) along cross-section C-C of FIG. 4A. Latch legs (11a-11d) are shown being inserted into recess (24a-24d) as the splice cap is being pressed into the base opening in the direction of the arrows. FIG. 5B depicts pressing down the splice cap where surface (14a) moves outward inner surface (37a) so surface (35a) will move downward under the guidance of surface (26a) pushing fiber press block (30) downward, which closes V-groove (22) about the optical fibers.

Referring to FIG. 6A and FIG. 6B. FIG. 6A operation is the same as FIG. 5B, and FIG. 6A depicts gap “G” that is open so optical fiber (50) is not yet secured within the V-groove of the base. A user pushes down on splice cap (10) in direction of arrow “A” to close the V-groove about the abutted optical fiber pair positioned within the V-groove that runs longitudinally along the mechanical splice assembly. Guidance surface (26a) also controls “Z” position of splice cap (10). FIG. 6B depicts movements in the direction of the arrows, of base (20), fiber press block (30) and splice cap (10) to close V-groove (22) and its gap (G) about optical fiber (50).

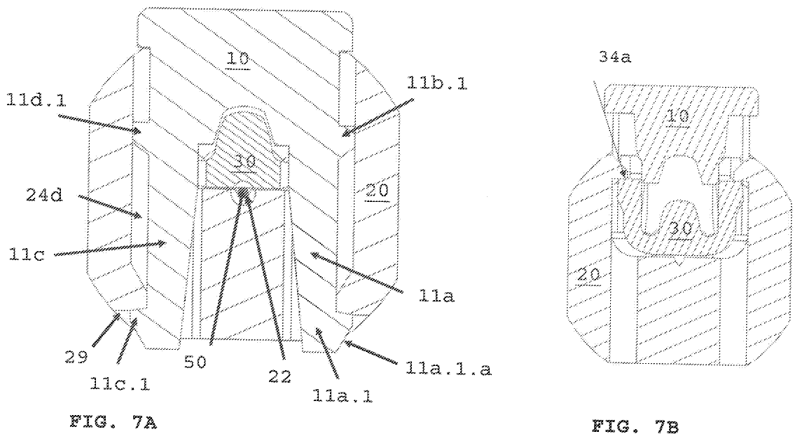

FIG. 7A depicts splice cap (10) fully inserted through base (20) recesses (24a-24d) and catches (11a.1, 11c.1) as shown latch beneath bottom portion (29) which closes V-groove (22) about spliced optical fiber pair (50,50′). FIG. 7B depicts surface (34a) which also controls “Z” direction positioning of splice cap (10).

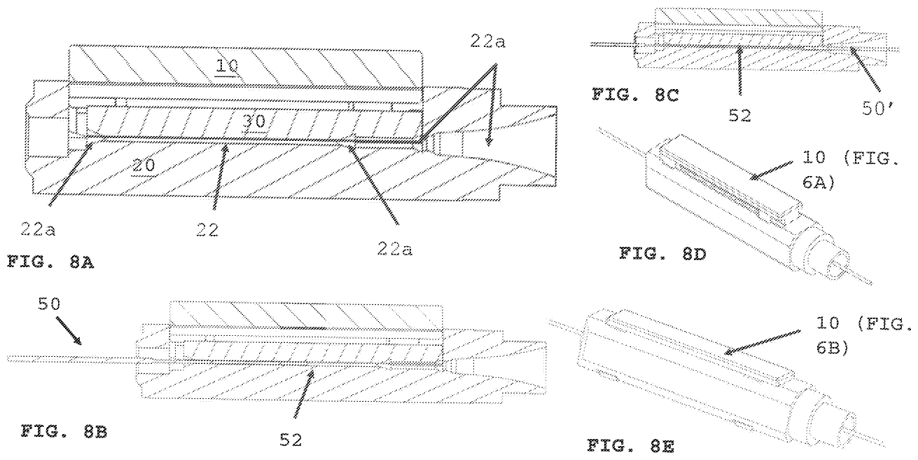

FIG. 8A depicts cross-section along the “X” axis or longitudinal axis of mechanical splice assembly (100). Splice cap (30) is partially inserted into base (20) which has fiber press block (30) secured in the base. Since the splice cap is not fully inserted a pair of opposing optical fibers can inserted at proximal end (102) and distal end (101) using guidance channels (22a) to feed the optical fibers to abut one another before fully inserting the splice cap and closing the V-groove as described in FIG. 6B. FIG. 8B depicts first optical fiber 50 inserted into proximal end (202) along V-groove (22) to splice point (52). FIG. 8C depicts inserting a second optical fiber (50′) using guidance channels along V-groove (22) until the optical fiber abuts one another at splice point (52). FIG. 8D depicts partially inserted splice cap (10) after opposing optical fibers are inserted into assembly (100). FIG. 8E depicts fully inserted splice cap (10) in closed position securing splice joint (52) as described in FIG. 6B.

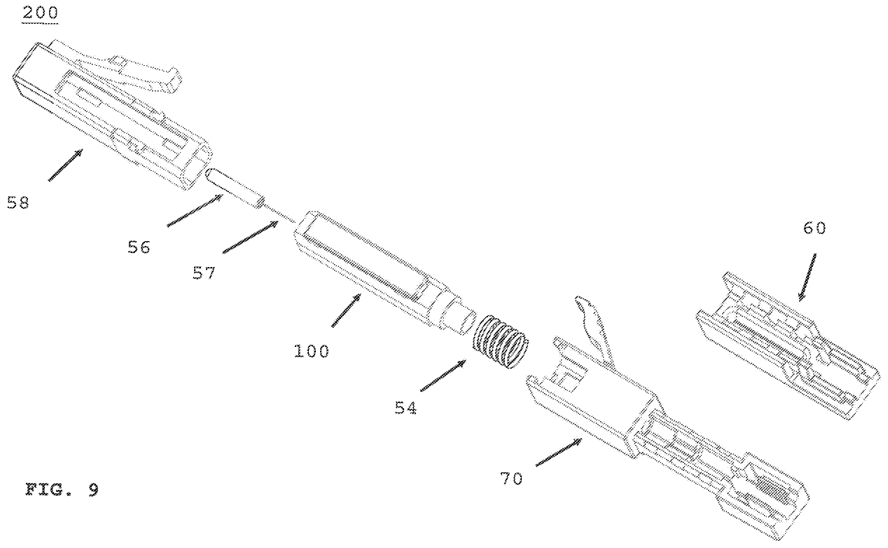

FIG. 9 depicts an exploded view of a fiber optic connector deploying the mechanical splice assembly. Plug frame (58) accepts mechanical splice assembly (100) with ferrule (56) and its optical pigtail (57) inserted into assembly (100) at proximal end (102). The distal end of the assembly (100) accepts bias spring (54). Rear body (70) is latched to a distal end of the plug frame to capture the assembly (100) and spring (54) forming fiber optic connector (200). Rear body (70) is configured to secure a fiber optic cable with cable cover (60).

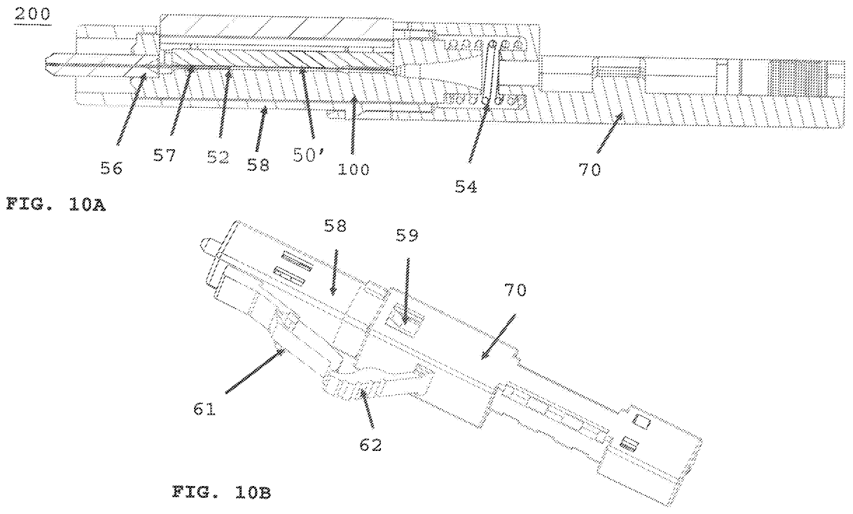

FIG. 10A depicts a cross-section of fiber optic connector (200). Fiber splice joint (52) is formed from optical pigtail (57) and optical fiber (50) from the fiber optic cable at the distal end of the connector. FIG. 10B depicts a side view of rear body (50) latched (59) with plug frame (58). Adapter latch (61) and thumb release (62) are shown, the thumb release is to remove the connector from the adapter port.

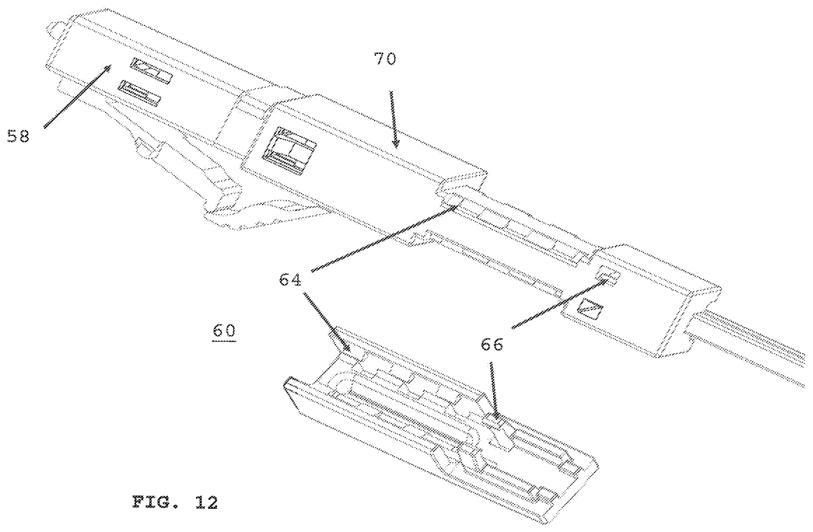

FIG. 11A depicts the prior art operation of stripping cable jacket (53), strength members (55), protective coating (51) leaving optical fiber (50) for cleaving then splicing according to the present invention. FIG. 11B depicts fiber cable (63) secured within clamp assembly (65). FIG. 11C depicts coated portion of optical fiber (51) secured within V-groove to help reduce movement. FIG. 11D depicts overall length of fiber optic connector (200) no greater than 45 mm. Cable cover (60) is secured with rear body (70) holding in the fiber optic cable at the distal end of the fiber optic connector. FIG. 11E depicts the cable cover latched (69) to rear body (70). FIG. 12 depicts cable cover (60) latches (64, 66) when secured to rear body (70).

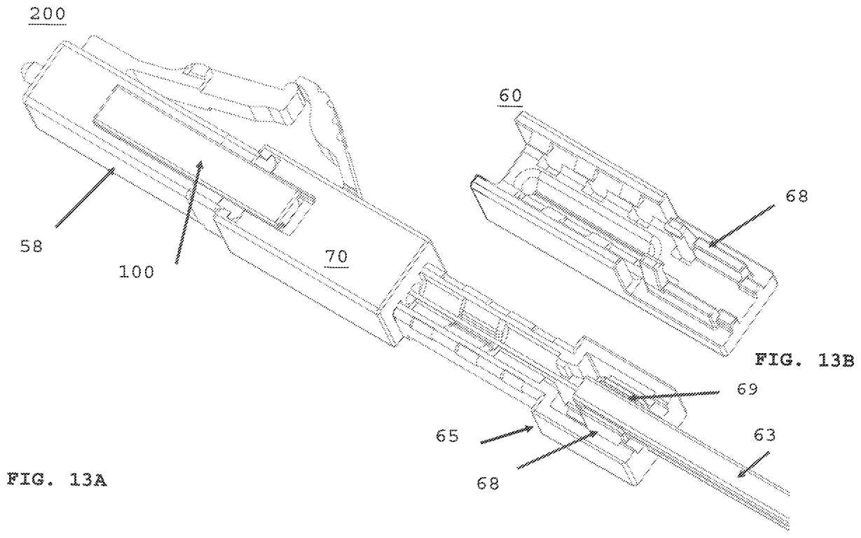

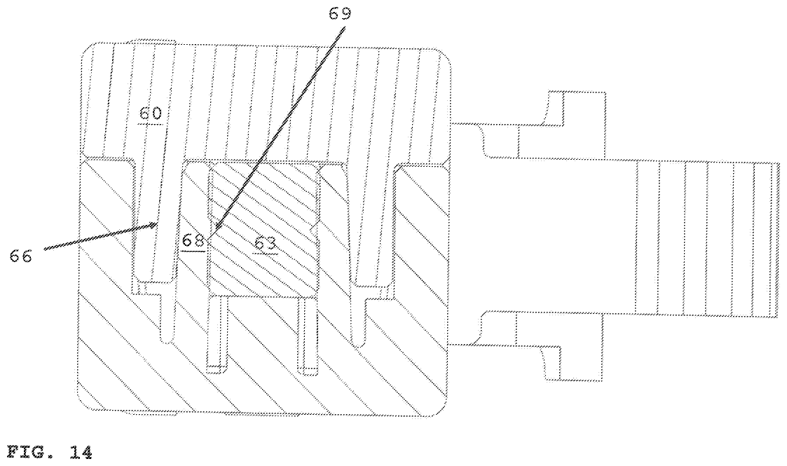

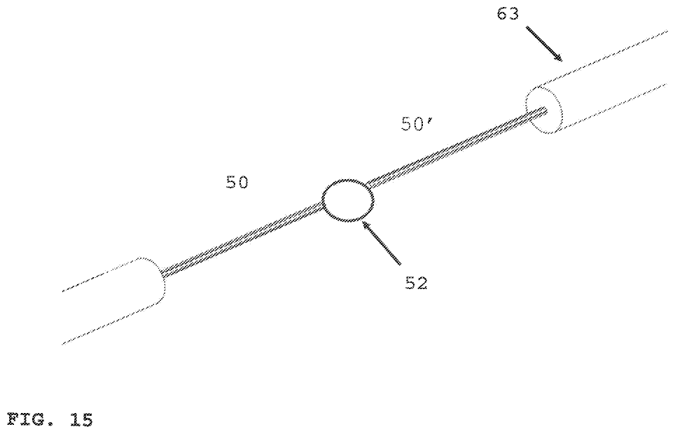

FIG. 13A depicts fiber optic connector (200) with cable (63) secured by ribs (69) supported by pad (68) that clamps about cable (68) when cable cover (60) (refer to FIG. 13B) is secured about clamp assembly (65). FIG. 14 depicts rib surface (68) binding into cable (63) and held in by latch (66) pushing on pad (68) into rib (68). FIG. 15 depicts opposing optical fiber (50, 50′) to form splice joint (52) when the opposing optical fiber abuts one another.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera).

1. A mechanical splice assembly, comprising:
a base formed by opposing sidewalls and a bottom portion with a V-groove formed as part of the bottom portion;
an opening in the base is configured to receive a fiber press block;
a first optical fiber is placed within the V-groove at a proximal end of the base and a second optical fiber is placed within the V-groove at a distal end of the base;
the first optical fiber abuts the second optical fiber forming an optical pathway;
a splice cap is inserted into the opening wherein a plural of splice latch legs force down the fiber press block to close the fiber channel formed by the V-groove thereby forming a mechanical splice between opposing optical fibers.

2. The mechanical splice assembly according to claim 1, wherein the mechanical splice assembly is inserted into a plug frame of a fiber optic connector.

3. The mechanical splice assembly according to claim 2, wherein a proximal end of the mechanical splice assembly is configured to accept a ferrule with the first optical fiber, the first optical fiber is at least one optical pigtail extending from a ferrule.

4. The mechanical splice assembly according to claim 1, wherein the distal end of the plug frame is configured to accept a rear body.

5. The mechanical splice assembly according to claim 4, wherein rear body further comprises opposing ribs configured to receive and secured a fiber optic cable from movement.

6. The mechanical splice assembly according to claim 5, wherein the opposing elastic teeth are compressed about the fiber optic cable when a cable cover is secured to a distal end of the rear body thereby preventing the fiber optic cable from being removed from the fiber optic connector.

7. The mechanical splice assembly according to claim 1, wherein the base further comprises a plural of guide channels, the plural of guide channels provide a conduit for feeding the opposing optical fibers along the V-groove until the optical fibers abut one another at a splice joint.

8. The mechanical splice assembly according to claim 2, wherein the plug frame is configured with an adapter latch for securing and releasing the fiber optic connector from an adapter port.

9. The mechanical splice assembly according to claim 4, wherein the distal end of the plug frame has a pair of opposing latches that secure the rear body to the plug frame.

10. The mechanical splice assembly according to claim 5, wherein a clamp assembly is secured to a distal end of the rear body and further wherein the clamp assembly houses the opposing ribs.

11. The mechanical splice assembly according to claim 10, wherein the clamp assembly latches to a clamp cover which forces the ribs into a cable jacket of the fiber optic cable.

12. The mechanical splice assembly according to claim 1, wherein the second optical fiber is a polymer optical fiber.

13. The mechanical splice assembly according to claim 3, wherein the ferrule is a mechanical transfer ferrule with a plural of optical fiber pigtails.

14. The mechanical splice assembly according to claim 1, wherein removing the splice cap opens the V-groove along a longitudinal length of the mechanical splice assembly providing access to the V-groove using a plural of fiber guidance channels to remove or to insert the first optical fiber and the second optical fiber within the mechanical splice assembly.

15. A fiber optic connector, comprising:
a mechanical splice assembly received in a plug frame;
a ferrule with an optical pigtail received at a proximal end of the plug frame,
a rear body secured to a distal end of the plug frame;
a fiber optic cable with a second optical fiber; and wherein the optical pigtail and the second optical fiber abut forming a mechanical splice when a splice cap of the mechanical splice assembly is secured with a base of the mechanical splice assembly.

16. The fiber optic connector according to claim 15, wherein the optical fiber is a polymer optical fiber.

17. A method of forming a field installable fiber optic connector, comprising:
providing a fiber optic connector according to claim 15;
inserting a ferrule with an optical fiber pigtail at a proximal end of a mechanical splice assembly;
positioning a bias spring at a distal end of the mechanical splice assembly;
securing a rear body with a cable clamp at a distal end of the plug frame;
fixing a cable cover over the cable clamp to secure the optical cable at a distal end of the fiber optic connector;
feeding a second optical fiber from the fiber optic cable until it abuts the optical fiber pigtail, and
inserting a splice cap over a fiber press block to splice the abutted optical fibers at a splice joint.

18. The method of forming a field installable fiber optic connector according to claim 17, wherein the step of preparing the incoming optical cable comprises:
stripping the cable jacket;
removing the strength members;
stripping the protective coating;
cleaving the optical fiber to form perpendicular endface with the optical fiber.
